(19) United States
(12) Patent Application Publication
(10) Pub. No.: US 2013/0082191 A1
(43) Pub. Date: Apr. 4, 2013

(54) STRESS-SENSITIVE MATERIAL AND METHODS FOR USING SAME

(71) Applicant: UNIVERSITY OF CENTRAL FLORIDA RESEARCH FOUNDATION, INC., Orlando, FL (US)

(72) Inventors: Seetha Raghavan, Oviedo, FL (US); Amanda Stevenson, Oviedo, FL (US); Ashley Jones, Melbourne, FL (US)

(73) Assignee: UNIVERSITY OF CENTRAL FLORIDA RESEARCH FOUNDATION, INC., Orlando, FL (US)

(21) Appl. No.: 13/630,236

(22) Filed: Sep. 28, 2012

Related U.S. Application Data
(60) Provisional application No. 61/541,436, filed on Sep. 30, 2011.

(51) Int. Cl. C09K 11/64; C09K 11/68; G01N 21/64

(52) U.S. Cl. 250/459.1; 252/301.36

(57) ABSTRACT

A stress-sensing material containing a matrix material and a photo-luminescent particle is disclosed, together with adhesives and coatings containing the stress-sensing material. Also disclosed are methods for preparing the stress-sensing material and measuring the stress on an article using the stress-sensing material.

### CROSS-REFERENCE TO RELATED APPLICATIONS

This application claims priority to U.S. Provisional Patent Application Ser. No. 61/541,436, filed on Sep. 30, 2011, which is hereby incorporated by reference in its entirety.

### BACKGROUND

1. Technical Field

The present disclosure relates to stress-sensitive materials and methods for using such materials, and specifically to stress-sensing materials comprising photo-stimulated luminescent particles.

2. Technical Background

Stress-sensing materials with high spatial resolution can be useful in assessing the structural health or impending failure of load bearing structures. When used as adhesives or surface coatings, such stress-sensing materials can enable non-destructive monitoring of the load bearing structures to which they are attached. When used as bonding adhesives, the stress-sensing materials can replace fasteners or rivets.

Traditional stress-sensing devices lack high spatial resolution and the ability to provide quantitative measurements that can relate to the integrity of a bond or structure prior to weakening and/or failure. Strain gauges are generally destructive in nature and lack the ability to achieve high spatial resolution. They also have limited capability to assess load transfer mechanisms and identify localized and/or time-related initiation of failure of significance in impact tests.

In various applications, such as aerospace technology, epoxy resins and other thermosetting polymers can be modified with filler materials to improve mechanical properties. Polymers with fillers can also serve as wear-resistant coatings to protect structural surfaces acting as surface coatings that would benefit from having a multi-functional stress-sensing capability. Research on the mechanisms of adhesive failure and effects of modifying filler particles in advanced adhesives would be greatly enhanced by the ability to map the stress evolution within the adhesive towards failure in standard adhesive tests with high spatial resolution. Thus, there remains a continuing desire for improvement in stress-sensing composite materials. These needs and other needs are satisfied by the compositions and methods of the present disclosure.

### SUMMARY

In accordance with the purpose(s) of the invention, as embodied and broadly described herein, this disclosure, in one aspect, relates to stress-sensitive materials, and specifically to stress-sensing coatings and/or adhesives comprising photo-stimulated luminescent particles.

In one aspect, the present disclosure provides a composite material comprising a matrix material and a photo-luminescent particle.

In another aspect, the present disclosure provides a method for measuring stress, the method comprising contacting a composite material comprising a matrix material and a photo-luminescent particle with at least a portion of an article, irradiating a portion of the composite material, and detecting at least one of the wavelengths of photo-luminescent emissions and/or the intensity of a luminescent signal produced by the particles in the composite material.

### BRIEF DESCRIPTION OF THE FIGURES

The accompanying figures, which are incorporated in and constitute a part of this specification, illustrate several aspects and together with the description serve to explain the principles of the invention.

FIG. 1 illustrates a stress-sensing adhesive application: (a) in a single lap-shear configuration, (b) utilizing a spectral mapping process while monitoring the (c) stress distribution with increasing load through contour maps of R1 peak positions on the overlap area, all in accordance with various aspects of the present disclosure.

FIG. 2 illustrates: (a) a compression test on alumina-filled nanocomposites; and (b) R-lines produced from α-alumina; PS coefficient results for (c) R1 and (d) R2, indicating a linear relationship between frequency shift and applied stress, as well as higher stress sensitivity with increasing particle content, all in accordance with various aspects of the present disclosure.

FIG. 3 illustrates: (a) a thermal experimental configuration, and measurements for (b) R1 and (c) R2, displaying a linear trend between peak position and temperature, in accordance with various aspects of the present disclosure.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

### Definition

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a particle” includes mixtures of two or more particles.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not. For example, the phrase “optionally substituted alkyl” means that the alkyl group can or can not be substituted and that the description includes both substituted and unsubstituted alkyl groups.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

A weight percent of a component, unless specifically stated to the contrary, is based on the total weight of the formulation or composition in which the component is included.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an ethylene glycol residue in a polyester refers to one or more —OCH₂CH₂O— units in the polyester, regardless of whether ethylene glycol was used to prepare the polyester. Similarly, a sebacic acid residue in a polyester refers to one or more —CO(CH₂)₈CO— moieties in the polyester, regardless of whether the residue is obtained by reacting sebacic acid or an ester thereof to obtain the polyester.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As briefly described above, the present disclosure provides a stress-sensing material that can be used as a coating and/or adhesive. In one aspect, high spatial resolution stress-sensing materials comprising particles can have potentially significant benefits in monitoring structural health and impending failure when used as adhesives or surface coatings on load-bearing structures. In such an aspect, these materials can provide non-invasive methods to assess the integrity and quality of polymer adhesives. In some industries, such as, for example, aerospace technology, the use of polymer adhesives and composites has rapidly increased. In one aspect, the use of such adhesives can minimize and/or eliminate stresses caused by conventional fasteners and rivets, along with reducing assembly time and the weight of the final structure.

In one aspect, the present disclosure provides a non-destructive, high spatial resolution approach for determining the real-time stress distribution within an adhesive and/or coating prior to failure. In various aspects, the present disclosure provides a stress-sensing material comprising a matrix material and one or more luminescent particles. In one aspect, the stress-sensing material can provide information regarding the stress exerted on the material. In another aspect, such information can be communicated through spectral information exhibited when the luminescent particles disposed therein are stimulated with, for example, radiation from a light source such as a laser. In yet another aspect, the peak positions of excited luminescent particles can provide a direct measure of the stress to which the particles, and thus the stress-sensing material, are subjected. In another aspect, photo-luminescent alumina particles can be embedded within a polymer matrix to monitor the stress distribution within the material in an in-situ configuration.

In another aspect, the stress-sensing material can comprise a plurality of particles disposed therein. In still another aspect, the stress-sensing material can comprise photo-stimulated luminescent particles at least partially embedded in a matrix material.

In one aspect, the stress-optical properties of a material can be determined as piezospectroscopic coefficients in compression experiments for composites containing varying volume fractions of photo-luminescent particles, with a direct empirical relationship between the applied stress and the spectral peak positions.

### Matrix Material

The matrix material of the present disclosure can comprise any material suitable for contacting with a photo-luminescent particle. In one aspect, the matrix material comprises a polymer or mixture of polymers. In another aspect, the matrix material comprises an epoxy. In a specific aspect, the matrix material can comprise an EPON resin. In another aspect, the matrix material can comprise a hardener, such as, for example, bisphenol A diglycidyl ether. In another aspect, the matrix material can comprise a bisphenol F epichlorohydrin resin. In still other aspects, the matrix material can comprise one or more elastomeric components. In yet other aspects, the matrix material can comprise other additives, curing agents, and/or components to impart desired properties for an intended application. In other aspects, the matrix material should be capable of allowing at least a portion of radiation, for example, laser radiation, incident upon a surface thereof to penetrate and contact a photo-luminescent particle disposed therein. In yet other aspects, the matrix material can comprise any standard polymer, additive, or combination thereof, that can be used, for example, in coatings and/or adhesives.

### Photo-Luminescent Particle

The photo-luminescent particle of the present disclosure can comprise any photo-luminescent particle or mixture of photo-luminescent particles suitable for use in a stress-sensing material. In one aspect, the photo-luminescent particle comprises alumina particles, such as, for example, α-alumina. In another aspect, the photo-luminescent particle comprises chromium doped α-alumina. While not wishing to be bound by theory, it is believed that the quantum efficiency of Cr⁺³ luminescence is sufficiently high to readily obtain luminescence signals when particles are embedded in a matrix material.

The size of any one or more of the photo-luminescent particles can vary depending upon, for example, the matrix material and intended application. In one aspect, all or a portion of the photo-luminescent particles can be on the order of nanometers, for example, from about 0.1 nm to about 1,000 nm. In another aspect, all or substantially all of the photo-luminescent particles can be on the order of nanometers. In another aspect, all or a portion of the photo-luminescent particles can be on the order of micrometers, for example, from about 0.1 μm to about 1,000 μm. In yet another aspect, all or substantially all of the photo-luminescent particles can be on the order of micrometers. In still another aspect, the photo-luminescent particles can comprise a mixture of nanosized and micronsized particles. In yet other aspects, at least a portion of the photo-luminescent particles can have dimensions less than or greater than any specific value recited herein, and the present invention is not intended to be limited to any particular particle size. It should also be appreciated that particle size can be a distributional property and that a range of particle sizes can be present in any given sample thereof.

In various aspects, the photo-luminescent particle or particles can be a filler in the matrix material, wherein the particles are disposed in the matrix material. In another aspect, the photo-luminescent particles are embedded within at least a portion of the matrix material. In one aspect, all or a portion of the particles can be distributed uniformly or substantially uniformly throughout the matrix material.

In various aspects, the quantity of photo-luminescent particles disposed in a matrix material can vary, depending upon, for example, the desired mechanical properties of the resulting material and/or the range of stresses intended to be measured using the material. In various aspects, the particles can comprise from about 1 wt. % to about 50 wt. % of the stress-sensing material, for example, about 1, 2, 3, 4, 5, 6, 7, 8, 9, 10, 12, 14, 16, 18, 20, 22, 24, 26, 28, 30, 32, 34, 36, 38, 40, 42, 44, 46, 48, or 50 wt. %. In other aspects, the particles can comprise less than about 1 wt. % or greater than about 50 wt. % of the stress-sensing material, and the present disclosure is not intended to be limited to any particular particle concentration.

### Stress Measurement

Most existing methods to determine stress require invasive and/or destructive analysis, and many lack the ability to provide high spatial resolution information on stresses in a material. Existing technologies to assess the integrity of structures and adhesives include thermography, laser bond inspections, and ultrasonic techniques. In contrast, the inventive stress-sensing materials can provide spectral information from the entire specimen surface, with results optionally being shown in contour plots to assess integrity.

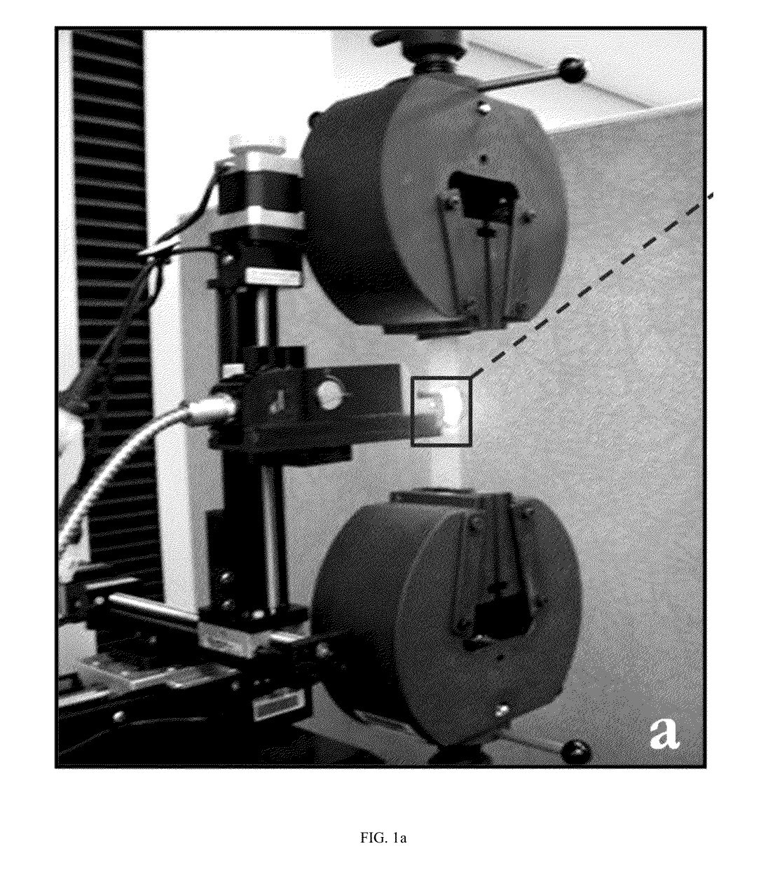

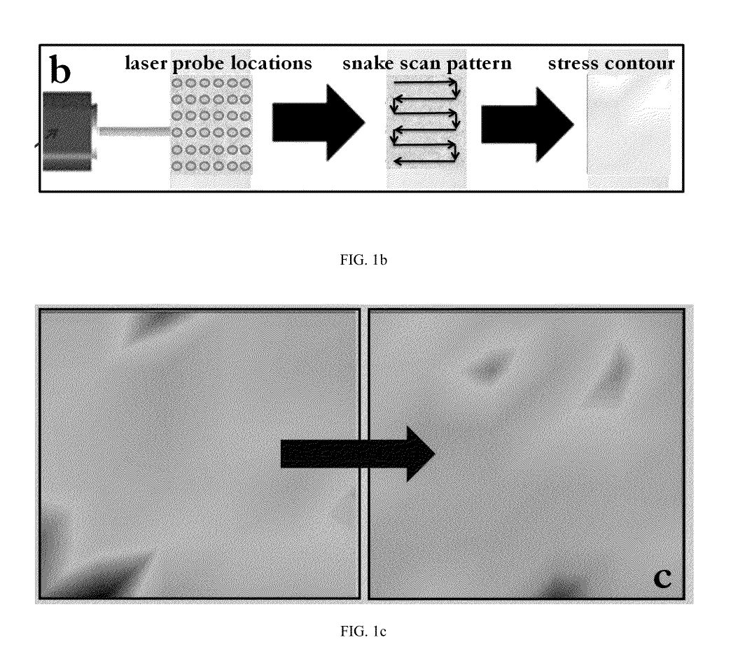

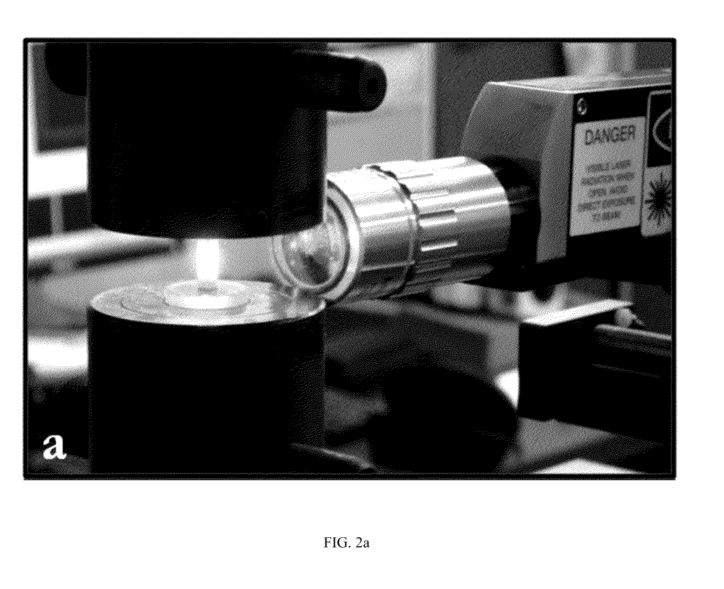

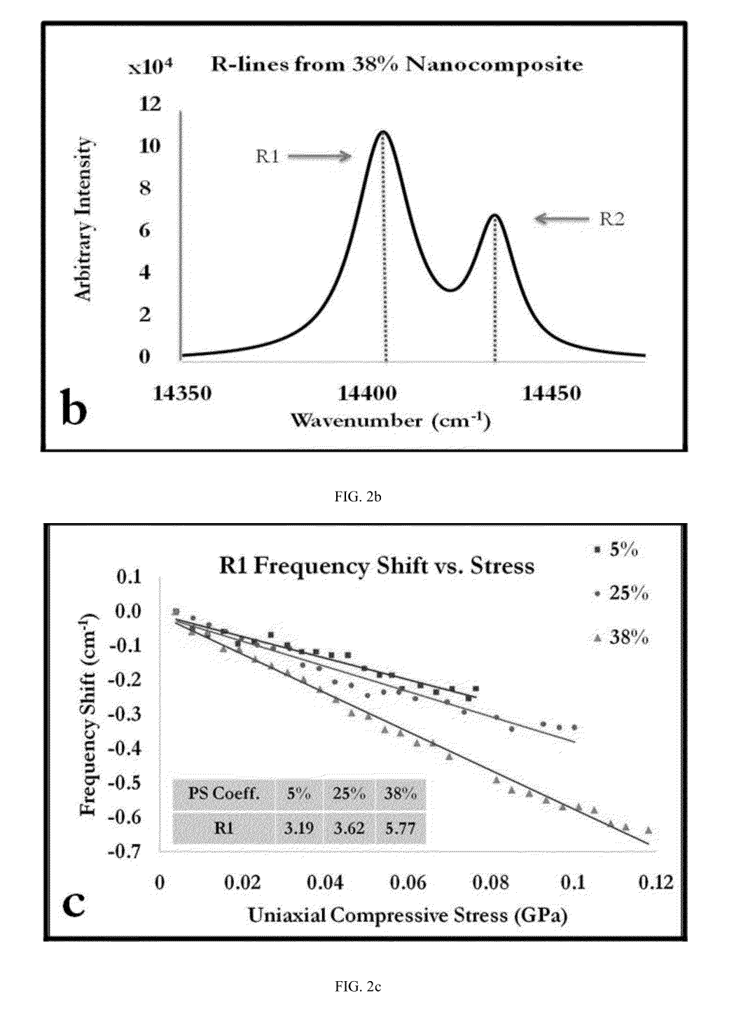

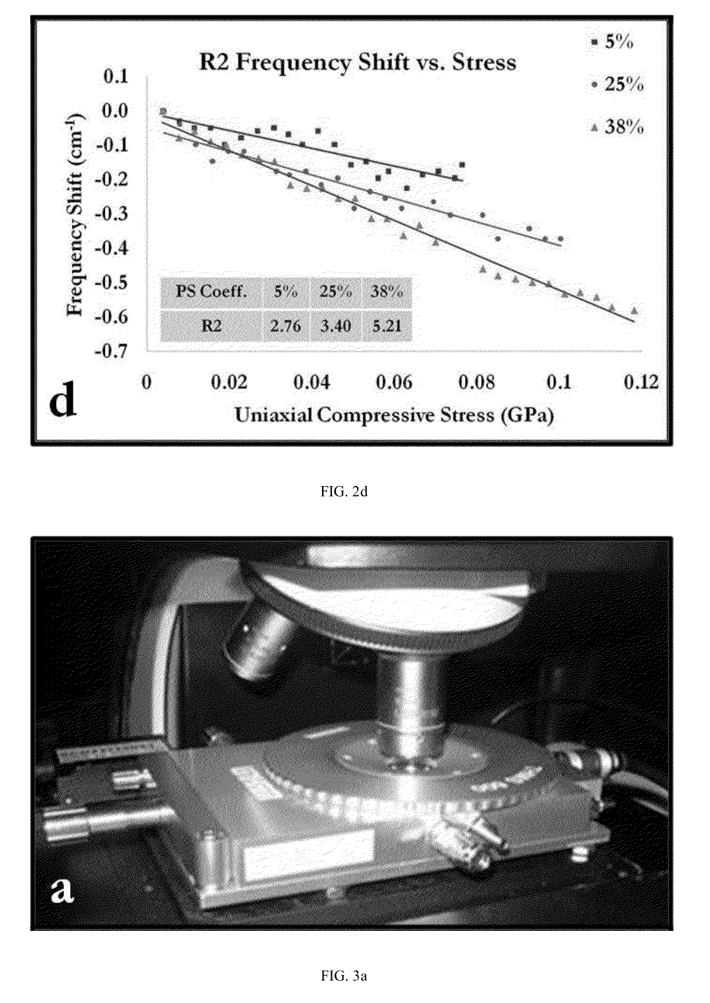

With reference to the figures, a single lap-shear experiment using an adhesive and fiber-glass substrates is illustrated in FIG. 1. In such an aspect, the weakening and eventual failure of a bonded joint can be predicted using this integrity monitoring technique by relating obtained quantitative stress measurements from photo-stimulated luminescence emission with the stress evolution of the material (FIG. 1c). The successful development of such high spatial resolution stress-sensing capabilities in adhesives can effectively be extended to coatings that can be applied directly on structures, as well as to matrix materials in composites with the appropriate calibration using piezospectroscopy. As a non-destructive technique, piezospectroscopy can measure stress-induced shifts of the photo-stimulated emission lines of the photo-luminescent particles (e.g., α-alumina) during laser excitation. In this example, the origin of these characteristic R-emission lines, as illustrated in FIG. 2b, are optical transitions between excited states and the ground state of Cr³⁺ ions within α-alumina.

In one aspect, an advantage of the inventive stress-sensing materials is the high spatial resolution of, for example, a few microns, which can be obtained. In this aspect, an excitation source, such as, for example, a laser, can be focused on one or more portions of a sample with an optical microscope or fiber optic probe. When using chromium doped α-alumina, the quantum efficiency of Cr³⁺ luminescence is sufficiently high that a measurable luminescence signal can easily be obtained in a polymer-system with fast collection times. When coupled with advances in piezospectroscopy (PS) methods, the piezospectroscopic properties of chromium-doped alumina can be engineered into advanced sensor technologies in the form of particulate-polymer composites.

In one aspect, stress calibration experiments can be performed on, for example, alumina-filled epoxy composites comprising varying volume fractions of filler particles, so as to obtain the relationship between spectral peak shift and stress known as the piezospectroscopic (PS) coefficients.

Conventional unreinforced polymers can exhibit poor resistance to crack initiation and propagation. Their mechanical properties are thus often enhanced prior to operational applications. In one aspect, the addition of nano or micron sized particles, such as, for example, mechanically strong particles, can improve the mechanical properties of, for example, a polymeric adhesive. In specific aspects, one or more of adhesion, toughness, and/or peel strength can be improved by incorporating such nano or micron sized particles.

In one aspect, stress calibration standards can be prepared using varying amounts of photo-luminescent particles in the matrix material, for example, about 5 vol. %, 25 vol. %, and 38 vol %).

In another aspect, uniform particle dispersion, to ensure even stress distribution throughout the inventive composites under loading conditions, can be assessed and verified using spectral intensity mapping. In one aspect, non-homogenous particle dispersion, which can facilitate agglomerations and allows for specific regions to absorb more stress than surrounding areas, is detected through intensity mapping.

The excitation or light source can comprise any excitation or light source capable of directing radiation to at least a portion of the photo-luminescent particles such that the particles emit radiation at a detectable wavelength. In one aspect, the excitation or light source can provide a collimated light beam having sufficient intensity so as to result in luminescence of the irradiated particles. In another aspect, the excitation or light source can comprise a laser. One of skill in the art, in possession of this disclosure, could readily select an appropriate excitation or light source for a specific particle, composite, or application.

In one aspect, a system comprising an MTS Insight electromechanical testing system, fiber optic probe (laser), XYZ stage, and Raman spectrometer, can be implemented to collect luminescence data under loading conditions, wherein the laser beam can first be focused on the 5% volume fraction specimen surface, using the intensity of the R1 peak as a calibration. The XYZ stage and probe can then be moved incrementally, for example, backward or forward, until the R1 curve achieves maximum intensity for optimal spectral data collection. In such an aspect, this position can be fixed and subsequently be used as the focus position. Similarly, such measurement and optimization steps can be applied to the R2 peak in addition to or in lieu of the R1 peak.

In subsequent analyses of samples, the laser beam can initially be set to the left-center of the surface and this position, along with the previously determined focusing distance, can be set as the reference location for all return motions, as shown in FIG. 1b.

A single spectrum or multiple spectra, for example, 3, 4, 5, or more spectra, can be obtained from each sample. In an exemplary aspect, individual spectra from 5 collection points on the surface of each sample can be collected in a horizontal line and the photo-luminescence data captured using 50 acquisitions per position shown to produce low standard deviations of 0.0086 (R1) and 0.0176 (R2), with a 1 second collection interval, at maximum laser power. In such an aspect, a neutral density filter of 40% transmissibility can be used to reduce the laser power provided to the 38% specimen so as to allow for constant experimental parameters to be used without saturation of the charged couple device (CCD). In this aspect, each of the α-alumina volume fraction specimens can be subjected to incremental, uniaxial, compressive or tensile loads, while photo-luminescent data is simultaneously collected in-situ. In this exemplary aspect, the electromechanical loading system can apply the load via steel platens with the addition of sapphire platens to account for the hardness of alumina (FIG. 2a). Incremental loads of 0.04 kN can be applied and held for 15 minutes each, while the photostimulated emission was collected. The load range applied to each volume fraction sample varied based on the mechanical strength of each sample as established during separate load range experiments. In one aspect, separate samples can be prepared and subjected to compressive and tensile loads, respectively. In such an aspect, samples subjected to a tensile load can provide tensile calibration data.

In this exemplary aspect, the results indicate shifts in the R-lines with increasing compressive load for each of the volume fraction composites. The data obtained from the spectral lines indicates a linear relationship between the peak shift and applied stress that is consistent with the piezospectroscopic behavior of α-alumina. Accordingly, the PS coefficients corresponding to each composite material were determined as the slopes of these shifts with stress established by the collected in-situ data as shown in FIGS. 2c and 2d. These coefficients exhibited similar behavior over 3 orders of magnitude to that of single crystal and polycrystalline alumina. The R1 PS coefficients are 3:19 cm⁻¹/GPa, 3:62 cm⁻¹/GPa and 5:77 cm⁻¹/GPa and the R2 PS coefficients were 2:76 cm⁻¹/GPa, 3:40 cm⁻¹/GPa and 5:21 cm⁻¹/GPa corresponding to volume fractions of 5%, 25%, and 38% respectively.

In a stress-sensing application, for a measurement of peakshift from a corresponding volume fraction sensing material, these PS coefficients can be used to establish the applied stress. Thus, in one aspect, the stress-sensing property of the inventive stress-sensing material can be directly utilized to measure stress distributions in adhesives and coatings with, for example, embedded α-alumina particles as shown in FIG. 1c. In other aspects, the inventive techniques described herein can be used to establish the surface stress distributions on load bearing structures, such as aircraft wing skins

In another aspect, it is believed that the magnitude of the R1 and R2 PS coefficients can be directly correlated with the quantity of filler material (volume fraction) present in the stress-sensing material.

Thus, in one aspect, the sensitivity of the stress-sensing capability can be tailored based on the volume fraction of particles added. For example, the trend of increasing load transfer with higher volume fractions is consistent with the improved mechanical properties of similar composites that have been tested for mechanical strength.

While not wishing to be bound by theory, R1 and R2 results can exhibit similar trends, but can vary quantitatively. In one aspect, one of R1 or R2, for example, R1, can be more sensitive to frequency shift with stress. In another aspect, the peak depends on the stress. In another aspect, both R1 and R2 can be used to assess variations in particle size, morphology and the effects of particle surface modification (e.g., silane treatments) on the effectiveness of load transfer.

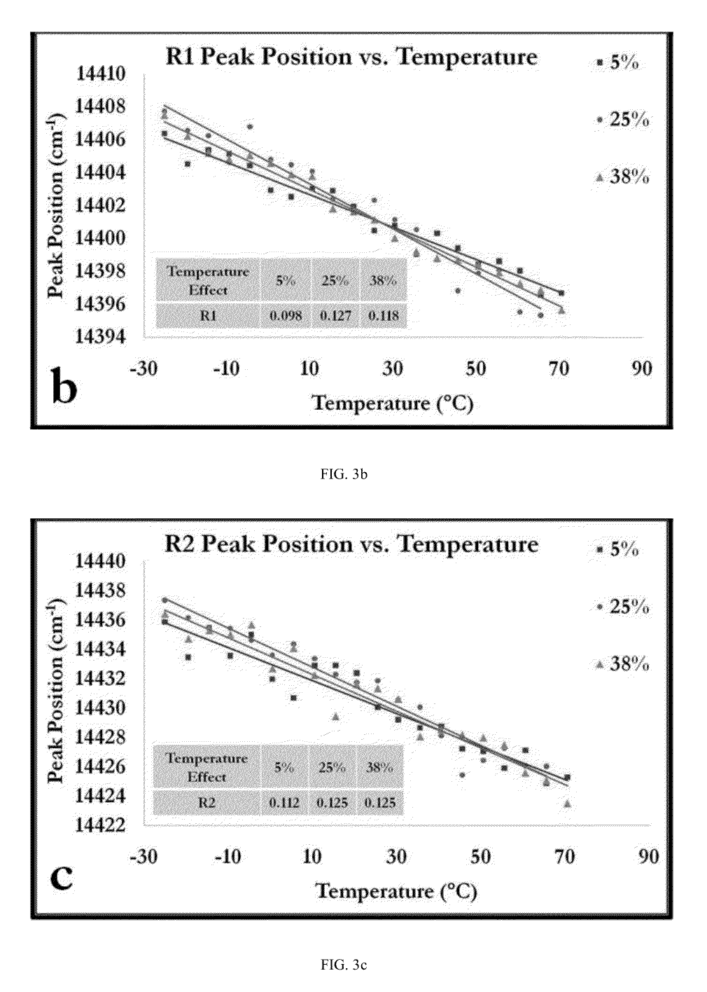

In another aspect, a temperature calibration can be performed on each sample and/or calibration standard to ensure that temperature variations do not adversely affect peak position. In one aspect, multiple readings can be obtained at various temperatures for each sample. In a specific aspect, each sample can be subjected to a temperature range of from about −25° C. to about 70° C., with readings obtained at 5° C. intervals. FIG. 3 presents an exemplary experimental configuration with corresponding results (FIGS. 3b and 3c), wherein a linear relationship between the frequency of the R-lines and temperature was observed.

### Applications

The inventive stress-sensing material can be useful in, for example, the aerospace industry. In various aspects, the stress-sensing materials can be useful both in the laboratory for developing and understanding the properties of materials and as a design element of structural components to provide monitoring capabilities regarding integrity and failure. As described above, the inventive stress-sensing material can act as a non-destructive, real-time monitor of stress.

In one aspect, the stress-sensing materials can be capable of indicating areas which contain voids, agglomerations, cracks, and/or inclusions. In another aspect, the stress-sensing materials are non-destructive and non-invasive. In yet another aspect, the stress-sensing materials can provide real-time monitoring of stresses that exist in a material. In a specific aspect, the stress-sensing materials can be used to detect damage or crack initiation.

In another aspect, the stress-sensing material and techniques described herein, such as mapping and determining particle dispersion, can provide high spatial resolution measurements, as compared to strain gauges, and can be used in laboratory and/or production environments.

In one aspect, the stress-sensing materials can be employed to monitor stresses in a material and thus, predict impending failure or integrity failure. In such an aspect, the relationship between stress distribution and time to failure can be monitored. The inventive materials provide inherent advantages over conventional methods, such as, for example, acoustic emission and thermography, which can only detect actual failures after initiation.

In another aspect, the inventive stress-sensing materials can provide quality control parameters in a manufacturing process.

In still another aspect, the spatial resolution capability can be useful in mapping the stress distribution in real time testing environments, such as, for example, wind tunnel tests.

While typical aspects have been set forth for the purpose of illustration, the foregoing descriptions should not be deemed to be a limitation on the scope of the invention. Accordingly, various modifications, adaptations, and alternatives may occur to one skilled in the art without departing from the spirit and scope of the present invention.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Stress-Sensing Adhesive

In a first example, a composite was prepared using a filler material comprising α-alumina powder having an average particle size of 150 nm and about 99.85% purity and an epoxy resin comprising Epon 862 coupled with Epikure W.

For each prepared sample, resin, curing agent, and powder were mixed using a high shear mixer for about 15 minutes. The resulting mixture was then placed in a sonicator for 20 minutes to ensure homogeneity of the particle distribution. After sonicating, the samples were subjected to a low-pressure desiccator-vaccuum system for approximately 45 minutes, or until no air bubbles were further visible. The samples were collected and poured into aluminum molds with dimensions 10 in×6 in×3.5 in. The molds were initially prepared with a mold release agent.

A two-step curing process with a duration of 6 hours at 54° C. and 16 hours at 93° C. was employed. Composites were then manufactured to various desired dimensions.

Photo-stimulated luminescence spectra were obtained using a Raman spectrometer coupled with an argon laser operating at 532 nm and having a maximum output power of 50 mW. The laser was directed through a fiber optic probe, exerting an output power from the probe of about 18 mW. An electromechanical testing apparatus was employed that had the capability to determine both tensile loads and compressive loads of up to 50 kN.

The experimental R-lines must be deconvoluted in order to determine the precise peak positions of each individual R-lines (i.e., R1 and R2). Accordingly, a genetic algorithm (GA) based procedure previously created and used to deconvolute and predict correct R-line and vibronic sideband peak positions for polycrystalline alumina was applied to the unprocessed experimental data. The fitting procedure used pseudo-Voigt functions to obtain the area, line-widths, peak positions, and shape factors for each of the R1 and R2 curves.

What is claimed is:

1. A method for measuring a stress, the method comprising contacting a composite material, comprising a matrix material and a photo-luminescent particle, with at least a portion of an article, irradiating a portion of the composite material with a laser, and detecting at least one of the wavelength and/or the intensity of a luminescent signal produced by the composite material.

2. The method of claim 1, further comprising correlating at least one of the peak position and/or intensity to a stress.

3. The method of claim 1, further comprising repeating the detecting step for a plurality of locations on the composite material to provide a stress map.

4. A composite material comprising a matrix material and a photo-luminescent particle.

5. The composite material of claim 4, wherein the matrix material comprises a polymer.

6. The composite material of claim 4, wherein the matrix material comprises an Epon resin.

7. The composite material of claim 4, wherein the photo-luminescent particle comprises α-alumina.

8. The composite material of claim 7, wherein the α-alumina is doped with chromium.

9. The composite material of claim 4, comprising a plurality of photo-luminescent particles disposed in the matrix material.

10. The composite material of claim 9, wherein the plurality of photo-luminescent particles are uniformly or substantially uniformly distributed in the matrix material.

11. The composite material of claim 4, wherein the photo-luminescent particle has at least one nanometer scale dimension.

12. The composite material of claim 4, wherein the photo-luminescent particle has at least one micrometer scale dimension.

13. An adhesive comprising the composite material of claim 4.

14. A coating comprising the composite material of claim 4.
